(19) United States
(12) Patent Application Publication
(10) Pub. No.: US 2005/0246346 A1
(43) Pub. Date: Nov. 3, 2005

(54) Secured authentication in a dynamic IP environment

(76) Inventors: Reiner J. Gerdes, Atlanta, GA (US); Samuel D. Davis, Lawrenceville, GA (US); Joseph A. Dudar, Roswell, GA (US); Fred Stearns, Acworth, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/942,195

(22) Filed: Sep. 16, 2004

Related U.S. Application Data
(60) Provisional application No. 60/566,678, filed on Apr. 30, 2004.

(51) Int. Cl. G06F 7/00

(52) U.S. Cl. 707/10

(57) ABSTRACT

In one embodiment, after establishing a packet data connection (1XRTT or GPRS) and obtaining an IP address, the remote data device registers with the proxy server using UDP packets. The remote data device periodically transmits UDP packets to the proxy server to maintain the registration and possibly any NAT/firewall translations (for the UDP session) in the cellular network. The proxy server is configured to listen on a different TCP port for the remote data device. This is a fixed port number for any given remote data device and is used for addressing the remote data device by the central data acquisition system that wants to access the remote data device. When the proxy server receives a TCP connection (from the central data acquisition system) on the port for a specific remote data device, the proxy server marks the remote data device as being busy and transmits a UDP message to the remote data device informing it that a connection is requested. If the proxy server does not receive a TCP connection from the remote data device, the proxy server transmits connection no-acknowledge message to the central data acquisition system, and marks the remote data device as being idle. Upon receipt of the connection request message, the remote data device establishes a TCP session with the proxy server. The proxy server establishes communication between the central data acquisition system and the remote data device. If the proxy server can establish communication, the proxy server terminates communication and marks the remote data device as being idle.

### CROSS-REFERENCE TO RELATED APPLICATION

This application claims priority to copending U.S. provisional application entitled, “Secured Authentication In A Dynamic IP Environment having Ser. No. 60/566,678, filed Apr. 30, 2004, which is entirely incorporated herein by reference.

### TECHNICAL FIELD

The present invention is generally related to secure data communication between a polling system that includes a central data acquisition system and a remote data device and, more particularly, is related to a system and secure authentication method using encryption for registering a remote data device with a proxy server and connecting a polling central data acquisition system to the remote data device via the proxy server.

### BACKGROUND OF THE INVENTION

Packet data transmission, such as Code Division Multiple Access (CDMA2000-1x Radio Transmission Technology (1XRTT), General Packet Radio Service (GPRS) or Enhanced Data GSM Environment (EDGE) is now widely available over CDMA and Global System for Mobile Communication (GSM) cellular networks. Typically, cellular carriers assign IP addresses to remote (mobile) data devices that are dynamic, i.e. IP addresses may change from one data call to the next. The cellular carriers assign dynamic (frequently changing) IP addresses to the remote data devices for various reasons and they are using Network Address Translation (NAT) on GPRS.

If the remote data device incorporates a modem/transceiver with an assigned dynamic IP address, a central data acquisition system cannot access the remote data device using a TCP/IP connection. Although the remote data device can contact the central data acquisition system, users with such central data acquisition systems are reluctant to open incoming TCP/IP ports due to security concerns.

When dynamic IP addresses are assigned to remote data devices, polling from the central data acquisition system to the remote data devices is essentially impossible. Clearly, this places a serious drawback on the deployment of remote data devices using packet data. This applies to remote data devices that collect data from utility meters, vehicles equipped with GPS, medical or industrial monitoring, and control equipment. In addition, the drawback prevents network efficiencies that are inherent in polling operations.

Packet data networks with fixed IP addresses such as CDPD (Cellular Digital Packet Data) are available from several cellular carriers. However, CDPD, in particular, is tied to the use of the AMPS analog network. CDPD will be terminated during 2005, according to announcements by several cellular carriers (AT&T Wireless and Verizon Wireless). At the latest this will happen when AMPS will be turned off in a few years.

It is highly desirable to overcome the polling problem caused by using dynamically assigned IP addresses. To this end, a solution is provided that uses the Internet for a connection from a central data acquisition system through a proxy server to a remote data device. This will also offer users of CDPD to transition to packet data services offered over GSM and CDMA cellular networks.

### SUMMARY OF THE INVENTION

Embodiments of the present invention provide a system and method for registering a remote data device with a proxy server and connecting a polling central data acquisition system to the remote data device. In one embodiment, after establishing a packet data connection (1XRTT or GPRS) and obtaining an IP address, the remote data device registers with the proxy server using UDP packets. The remote data device periodically transmits UDP packets to the proxy server to maintain the registration and possibly any NAT/firewall translations (for the UDP session) in the cellular network.

The proxy server is configured to listen on a different TCP port for the remote data device. This is a fixed port number for any given remote data device and is used for addressing the remote data device by the central data acquisition system that wants to access the remote data device. When the proxy server receives a TCP connection (from the central data acquisition system) on the port for a specific remote data device, the proxy server marks the remote data device as being busy and transmits a UDP message to the remote data device informing it that a connection is requested. If the proxy server does not receive a TCP connection from the remote data device, the proxy server transmits connection no-acknowledge message to the central data acquisition system, and marks the remote data device as being idle.

Upon receipt of the connection request message, the remote data device establishes a TCP session with the proxy server. The proxy server establishes communication between the central data acquisition system and the remote data device. If the proxy server can not establish communication, the proxy server terminates communication and marks the remote data device as being idle.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of an embodiment of a data communication system that enables communication between a central data acquisition system and a remote data device.

FIG. 2 is a block diagram of an embodiment of a proxy server shown in FIG. 1.

FIG. 3 is a block diagram of an embodiment of a remote data device shown in FIG. 1.

FIG. 4 is a flow diagram that illustrates an embodiment of operation of the system shown in FIG. 1 in registering a remote data device with a proxy server to facilitate communication between the remote data device and a central data acquisition system.

FIG. 5 is a flow diagram that illustrates an embodiment of operation of the system shown in FIG. 1 in connecting a polling central data acquisition device to a remote data device.

FIG. 6 is a flow diagram that illustrates an embodiment of operation of the remote manager 21 shown in FIGS. 1 and 3 in registering a remote data device with a proxy server.

FIG. 7 is a flow diagram that illustrates an embodiment of operation of the proxy manager 19 shown in FIG. 1 and 2 in registering a remote data device with a proxy server.

FIG. 8 illustrates an example of an embodiment of a UDP message format used in the data communication system shown in FIGS. 1 and 4-7.

FIG. 9 illustrates an example of an embodiment of a registration request message using the UDP message format shown in FIG. 8.

FIG. 10 illustrates an example of an embodiment of an authentication challenge message using the UDP message format shown in FIG. 8.

FIG. 11 illustrated an example of an embodiment of an authentication response message using the UDP message format shown in FIG. 8.

### DETAILED DESCRIPTION OF THE PREFERRED EMBODIMENT

Disclosed here are systems and methods through which a data communication can be established between a remote data device and a central data acquisition system. In particular, the data communication is established using a proxy server and the Internet for connecting a polling central data acquisition system to a remote data device. Example systems are first discussed with reference to the figures. Although these systems are described in detail, they are provided for purposes of illustrations only and various modifications are feasible. After the example systems have been described, examples of operation of the systems are provided to explain the manners in which data communication can be achieved. After the examples of operation of the systems have been described, examples of operation of a remote manager and a proxy manager are provided to explain the manners in which the remote data device establishes communication with the proxy server. After the examples of operation of the remote manager and the proxy server have been described, examples of unique data packet (UDP) messages are provided to explain the data that were exchanged when the remote data device registers with the proxy server.

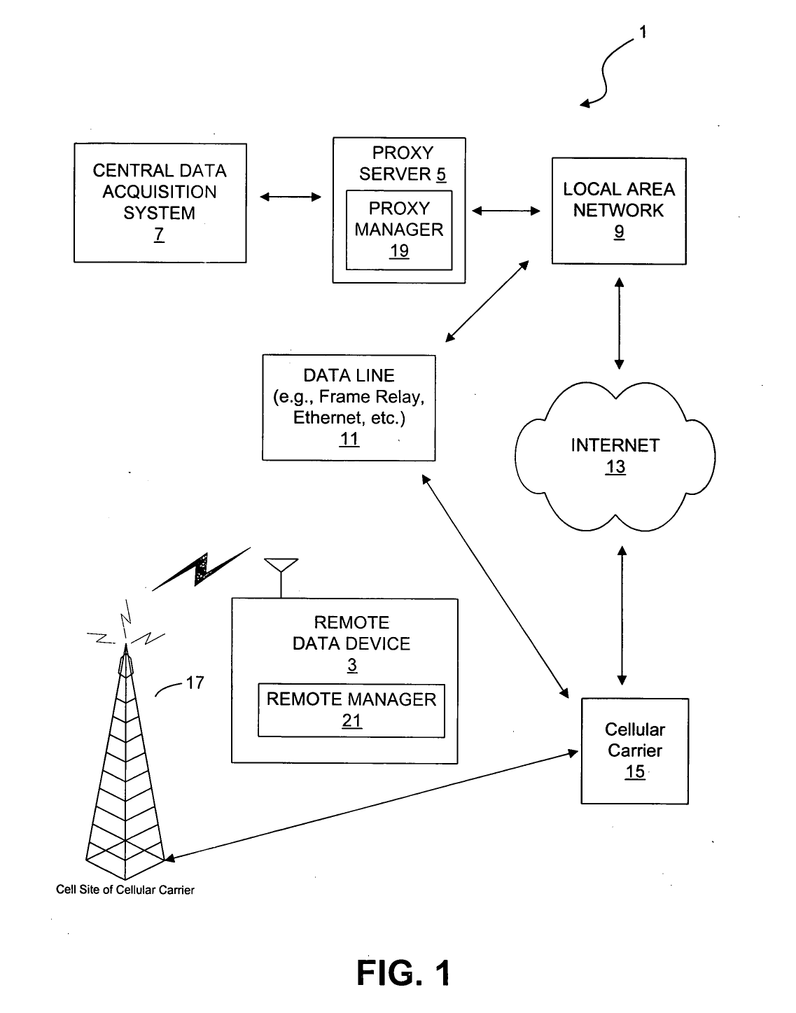

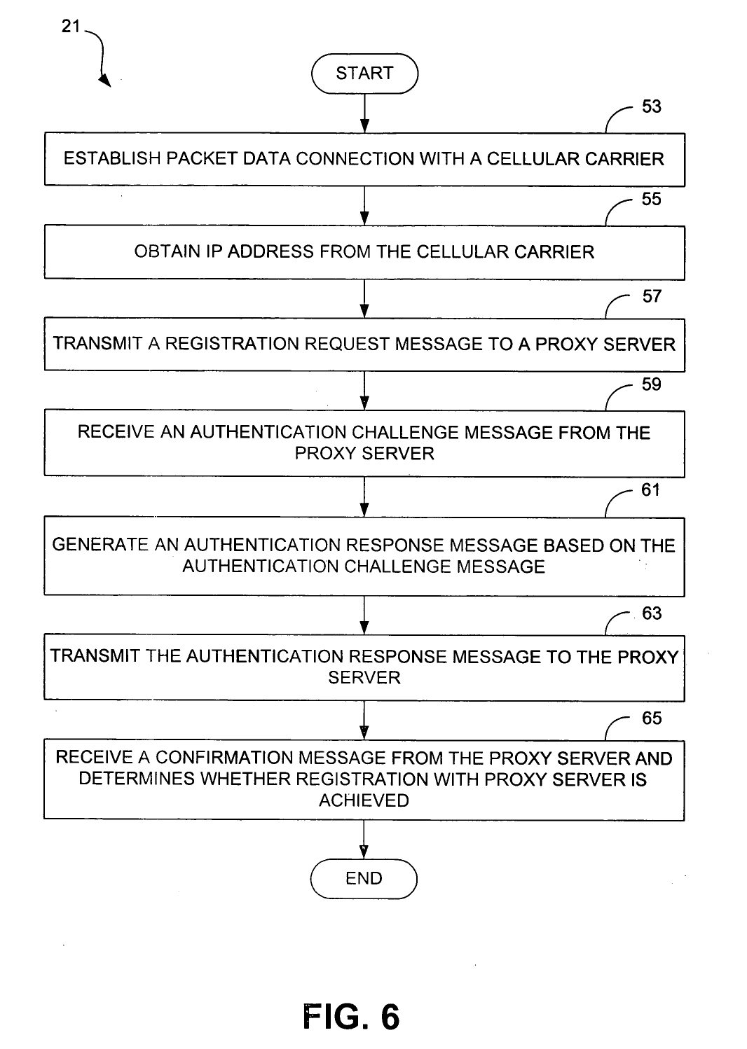

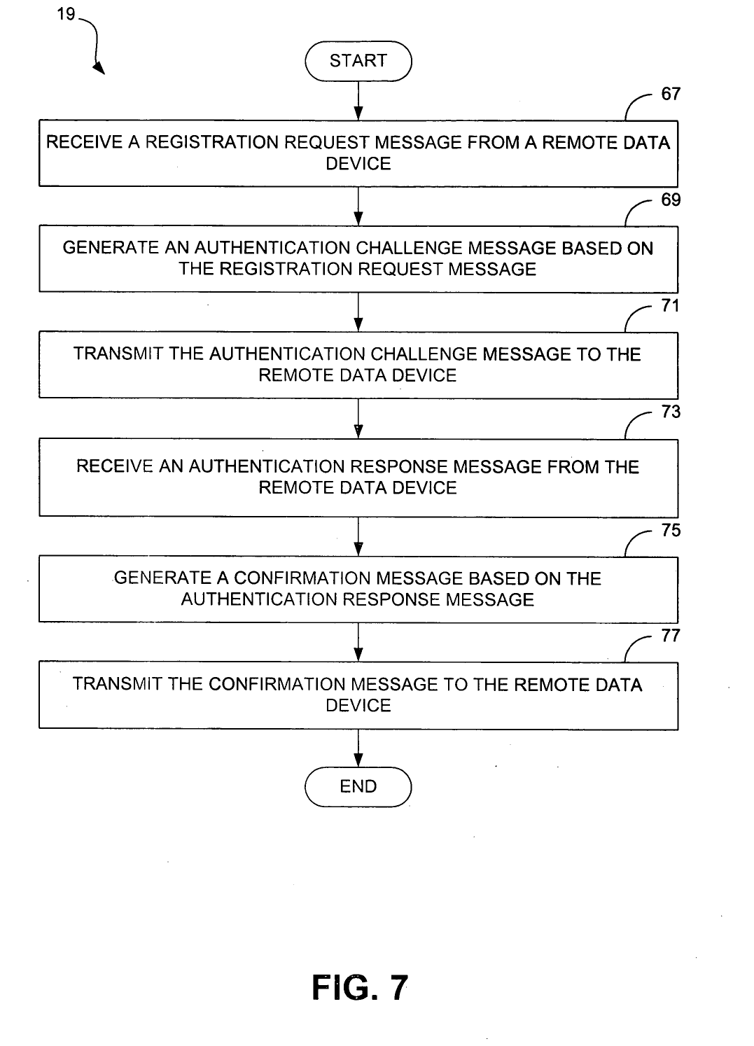

Referring now in more detail to the figures in which like reference numerals identify corresponding parts, FIG. 1 is a schematic view of an embodiment of a data communication system that enables communication between a central data acquisition system and a remote data device. Referring to FIG. 1, the communication system 1 includes a remote data device 3, a proxy server 5, a central data acquisition system 7, a local area network 9, a data line 11, an Internet 13, a cellular carrier 15, and a cellular tower 17. The central data acquisition system 7 communicates with the remote data device 3 via the local area network 9, cellular carrier 15, data line 11 and cellular tower 17. The remote data device 3 includes a cellular transceiver (not shown) that transmits and receives data from the cellular tower 17. The remote data device 3 further includes a remote manager 21 that is stored in a computer-readable medium. The proxy server 5 includes a proxy manager 19 stored in a computer-readable medium. Both the proxy manager 19 and the remote manager 21 facilitates a secured communication between the remote data device 3 and the central data acquisition system 7, which is described in relation to FIGS. 6 and 7.

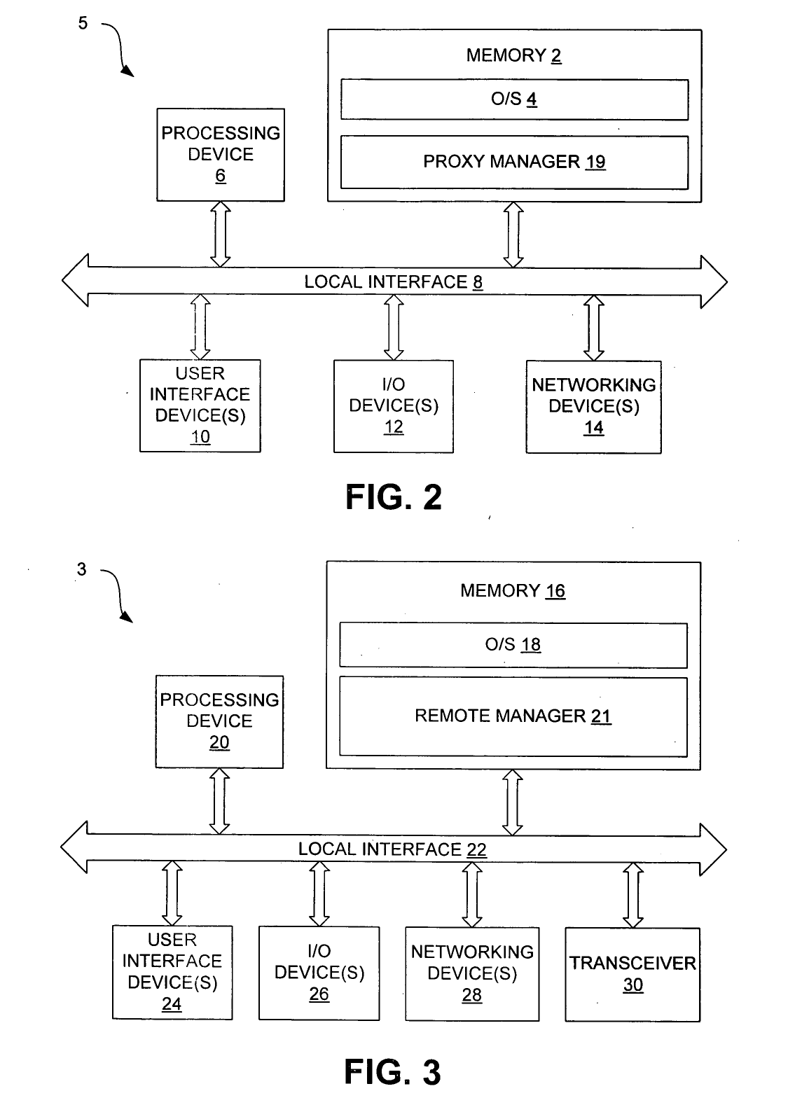

FIG. 2 is a block diagram illustrating an exemplary architecture for the proxy server 5 shown in FIG. 1. As indicated in FIG. 2, the proxy server 5 comprises a processing device 6, memory 2, one or more user interface devices 10, one or more I/O devices 12, and one or more networking devices 14, each of which is connected to a local interface 8. The processing device 6 can include any custom-made or commercially available processor, a central processing unit (CPU) or an auxiliary processor among several processors associated with the proxy server 5, a semiconductor based microprocessor (in the form of a microchip), or a macroprocessor. The memory 2 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 10 comprise those components with which the user (e.g., administrator) can interact with the proxy server 5. The proxy server 5 can have components that are typically used in conjunction with a PC, such as a keyboard and mouse.

The one or more I/O devices 12 include components used to facilitate the connection of the proxy server 5 to other devices and therefore, for instance, include one or more serial, parallel, small system interface (SCSI), universal serial bus (USB), or IEEE 1394 (e.g., Firewire™) connection elements. The networking devices 14 include the various components used to transmit and/or receive data over the network, where provided. By way of example, the networking devices 14 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 2 normally comprises various programs (in software and/or firmware) including an operating system (O/S) 4 and a proxy manager 19. The O/S 4 controls the execution of programs, including the proxy manager 19, and provides scheduling, input-output control, file and data management, memory management, and communication control and related services. The proxy manager 19 facilitates the process for registering the remote data device 3 with the proxy server 5 and connecting the polling central data acquisition system 7 to the remote data device 3. Typically, the process involves receiving data corresponding to the remote data device 3 via the Internet 13, and registering the remote data device 3 with the proxy server 5 in accordance with the received data, which is described in relation to FIG. 7. The process further includes facilitating the connection of the polling central data acquisition system 7 with the remote data device 3.

FIG. 3 is a block diagram illustrating an exemplary architecture for the remote data device 3 shown in FIG. 1. The architecture for the remote data device 3 is similar to the architecture of the proxy server 5 described above and therefore includes a processing device 20, one or more user interface devices 24, one or more I/O devices 26, and one or more networking devices 28, each of which is connected to a local interface 22.

The memory 16 in the remote data device 3, however, includes a remote manager 21 that facilitates registration of the remote data device 3 with the proxy server 5 and connection between the central data acquisition system 7 and the remote data device. 3. The process involves transmitting data from to the remote data device 3 via the Internet 13, which is described in relation to FIG. 6. The remote manager 21 further includes facilitating the connection of the polling central data acquisition system 7 and the remote data device 3. The architecture for the remote data device 3 further includes a transceiver 30 that transmits and receives data from a cellular tower 17.

Exemplary systems have been described above, so the system operation will now be discussed. In the discussions that follow, flow diagrams are provided. Any process steps or blocks in these flow diagrams may represent modules, segments, or portions of code that include one or more executable instructions to implement specific logical functions or steps in the process. Although particular example process steps are described, alternative implementations are feasible. Moreover, steps may be executed out of order from that shown or discussed, including substantially concurrently or in reverse order, depending on the functionality involved.

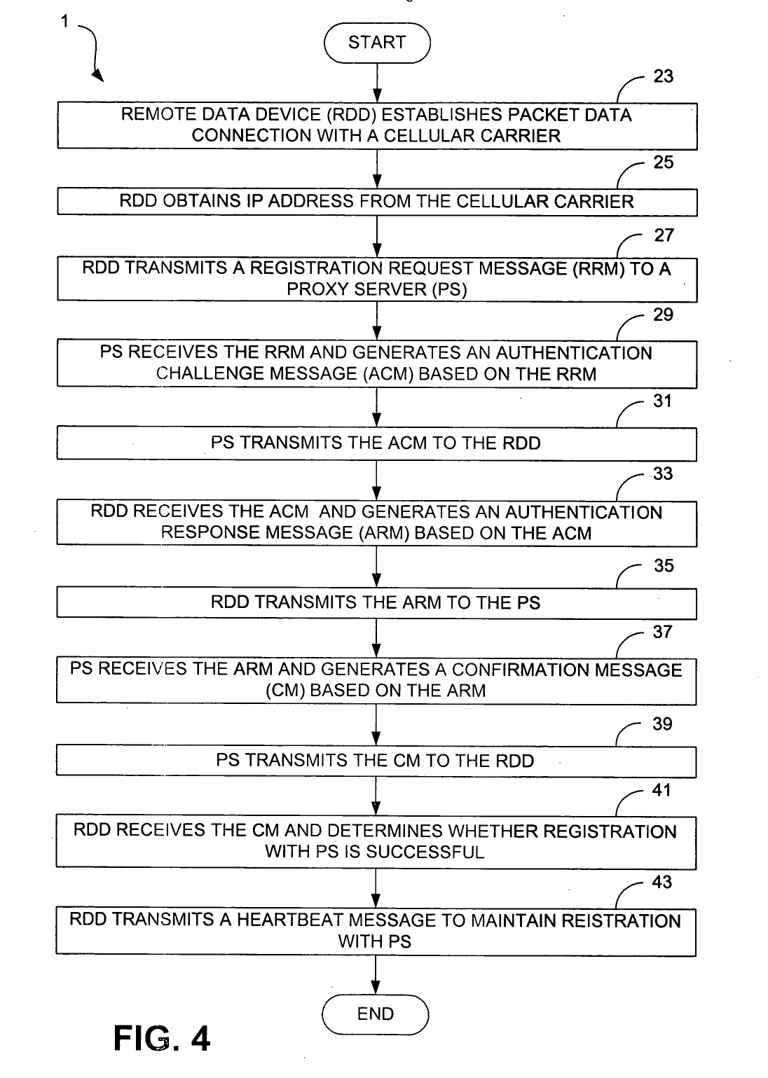

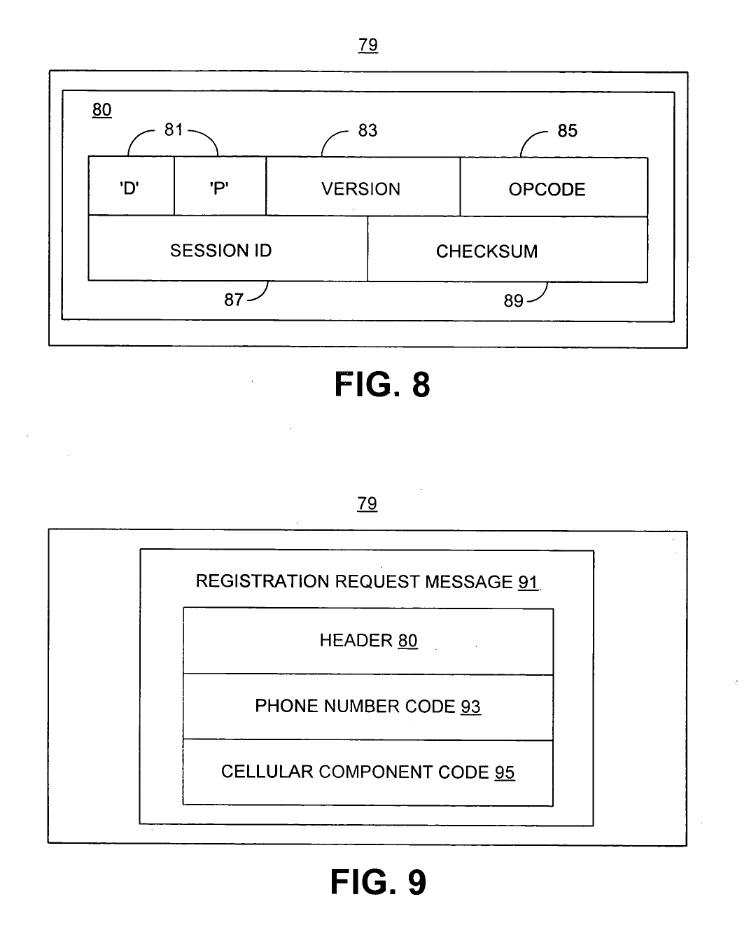

FIG. 4 is a flow diagram that illustrates an embodiment of operation of the system shown in FIG. 1 in registering a remote data device 3 with a proxy server 5 to facilitate communication between the remote data device 3 and the central data acquisition system 7. In block 23, the remote data device 3 establishes a packet data connection, e.g., 1XRTT or GPRS, with a cellular carrier 15, which assigns a dynamic IP address. In block 25, the remote data device 3 obtains the dynamic IP address for communication with the cellular carrier 15. After the remote data device 3 establishes communication with the cellular carrier 15 and obtains the IP address, the remote data device 3 registers with the proxy server 5 by transmitting unique data packets (UDPs) to the proxy server 5. The UDP message contains information on a protocol that the proxy server 5 uses to interpret the UDP messages. Some examples of the protocols are zero-knowledge, encrypted key exchange, SKID2, SKID3, challenge-response based on public-key decryption, challenge-response based on digital signatures, and GQ identification. The format of the UDP messages is described in relation to FIG. 8 and the different types of UDP messages (e.g., registration request, authentication challenge, authentication response, confirmation, etc.) are described in relation to FIGS. 9-11.

The block 27, the remote data device 3 transmits a registration request message to a proxy server 5 via the cellular carrier 15 and the Internet 13. The registration request message contains an identification code of the remote data device 3 and the IP address, which identifies the remote data device 3 to the proxy server 5. The content of the registration request message is described in relation to FIG. 9.

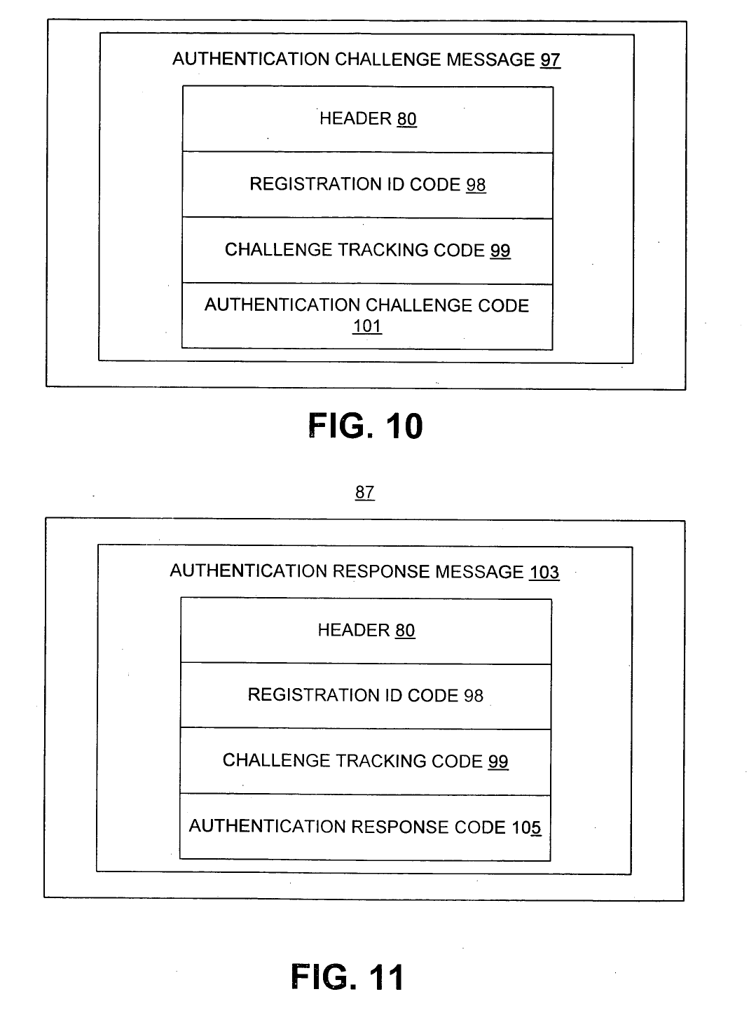

In block 29, the proxy server 5 receives the registration request message and identifies the remote data device 3 based on the registration request message. The proxy server 5 generates an authentication challenge message also based on the registration request message so as to request the remote data device 3 to authenticate itself. The content of the authentication challenge message is described in relation to FIG. 10.

In block 31, the proxy server 5 transmits the authentication challenge message to the remote data device 3. In block 33, the remote data device 3 receives the authentication challenge message and generates an authentication response message based on the authentication challenge message. Using data in the authentication challenge message and a secret password known to the proxy server 5 and the remote data device 3, the remote data device 3 generates an MD5 digest and transmits the MD5 digest to the proxy server 5 in the authentication response message. In block 35, the remote data device 3 sends the authentication response message to the proxy server 5. The content of the authentication response message is described in more detail with reference to FIG. 9.

In block 37, the proxy server 5 receives the authentication response message and generates a confirmation message as to whether a communication can be established between the remote data device 3 and the proxy server 5 based on the authentication response message. If the proxy server 5 verifies the digest in the authentication response message, the proxy server 5 responds with an authentication ACK code in the confirmation message, otherwise the proxy server 5 responds with an authentication NAK code. In block 39, the proxy server 5 transmits the confirmation message to the remote data device 3. In block 41, the remote data device 3 receives the confirmation message and determines whether registration with the proxy server 5 was achieved. Once registration is achieved, the remote data device 3 periodically transmits a heartbeat message to the proxy server 5 to maintain registration and to keep the NAT/firewall translation for UDP messages open to the remote data device 3. In response, the proxy server 5 sends a server heartbeat message to the remote data device 3.

It should be noted that the remote data device 3 registers with the proxy server 5 not only when the remote data device 3 has initialized communication with the cellular carrier 15, but also when the remote data device 3 obtains a new IP address from the cellular carrier 15. After the remote data device 3 obtains the new IP address, the remote data device 3 receives and transmits UDP messages to the proxy server 5 to register with the proxy server 5 as explained above.

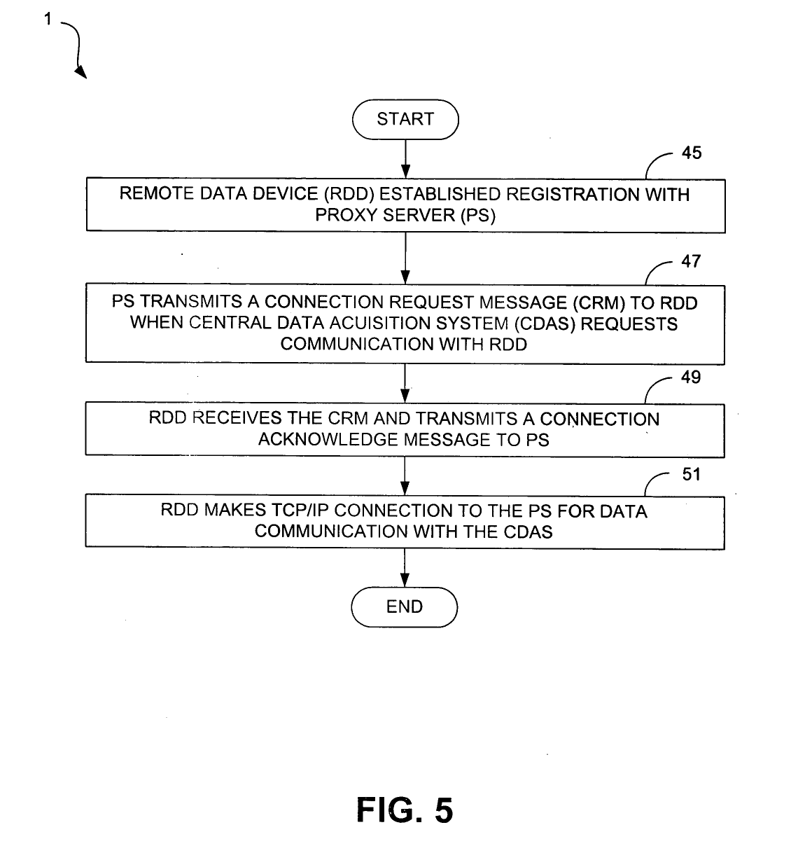

FIG. 5 is a flow diagram that illustrates an embodiment of operation of the system shown in FIG. 1 in connecting a polling central data acquisition device to a remote data device. As indicated in FIG. 5, in block 45, the remote data device 3 establishes registration with the proxy server 5 as explained in relation to FIG. 4. Referring now to FIG. 5, in block 47, the proxy server 5 transmits a connection request message to the remote data device 3 when the central data acquisition system 7 requests communication with the remote data device 3. The connection request message can contain information on a TCP/IP port that the remote data device 3 should connect to on the proxy server 5. The TCP/IP port information can provide more than one TCP/IP ports for the remote data device 3 to connect to the proxy server 5. In block 49, the remote data device 3 receives the connection request message and transmits a connection acknowledge message to the proxy server 5. The proxy server 5 can ignore the connection acknowledge message as a subsequent TCP connection can be coming in from the remote data device 3. The proxy server 5 can use the connection acknowledge message to determine whether the remote data device 3 received the connection request message. In block 51, the remote data device 3 makes a TCP/IP connection to the proxy server 5 for data communication with the central data acquisition system 7.

FIG. 6 is a flow diagram that illustrates an embodiment of operation of the remote manager 21 shown in FIGS. 1 and 3 in registering a remote data device 3 with a proxy server 5. In block 53, the remote manager 21 establishes a packet data connection, preferably in 1XRTT or GPRS, with a cellular carrier 15 and, in block 55, obtains an IP address from the cellular carrier 15. In block 57, the remote manager 21 transmits a registration request message to the proxy server 5 and, in block 59, receives an authentication challenge message from the proxy server 5. In block 61, the remote manager 21 generates an authentication response message based on the authentication challenge message and, in block 63, transmits the authentication response message to the proxy server 5. In block 65, the remote manager 21 receives a confirmation message from the proxy server 5 and determines whether registration with the proxy server 5 is achieved.

FIG. 7 is a flow diagram that illustrates an embodiment of operation of the proxy manager 19 shown in FIGS. 1 and 2 in registering a remote data device with a proxy server. In block 67, the proxy manager 19 receives a registration request message from the remote data device 3 and, in block 69, generates an authentication challenge message based on the registration request message. In block 71, the proxy manager 19 transmits the authentication challenge message to the remote data device 3 and, in block 73, receives an authentication response message from the remote data device 3. In block 75, the proxy manager 19 generates a confirmation message based on the authentication response message and, in block 77, transmits the confirmation message to the remote data device 3.

Exemplary system operations have been described above; the contents of a UDP message will now be discussed. The UDP message is communicated during the registration/authentication process between the remote data device and the proxy server and during the connection between the polling central data acquisition system and the remote data device. In the discussions that follow, block diagrams are provided. Any blocks in the block diagrams may be arranged in any particular sequence from that shown or discussed, including substantially concurrently or in reverse order.

FIG. 8 illustrates an example of an embodiment of a UDP message format in which the UDP message is used to register the remote data device 3 with the proxy server 5 and connect the polling central data acquisition system 7 to the remote data device 3. Each UDP message 79 can have a header 80, which includes a DP code, a version code, an opcode, a session ID code and a checksum code. The DP code identifies the UDP message. The version code identifies the protocol used to interpret the data. The opcode identifies the type of message, such as registration request, authentication challenge, authentication response, confirmation, heartbeat, restart, connection request, and connection acknowledgement.

The session ID code is used in various ways depending on the type of message. For example, in a registration request message, the remote data device 3 can set the session ID code to zero. In the authentication challenge message, the proxy server 5 can set session ID code to a unique value other than zero. In subsequent messages sent by the remote data device 3 after receiving the authentication challenge message, the remote data device 3 can use the value contained in the authentication challenge message. The proxy server 5 can use the value to identify a remote data device 3 for subsequent communications with the remote data device 3 (e.g., authentication response, heartbeat messages, etc.). In the connection request message, the remote data device 3 can set the session ID message to a TCP port number. The checksum code is used to validate the message.

FIG. 9 illustrates an example of an embodiment of a registration request message using the UDP message format shown in FIG. 8. The registration request message is sent by the remote data device 3 to the proxy server 5 to identify the remote data device 3 and the IP address that was obtained by the remote data device 3. The remote data device 3 transmits the registration request message to facilitate registering the remote data device 3 with the proxy server 5. After the remote data device 3 periodically completely reinitialize itself with the proxy server 5, the remote data device 3 transmits a registration request message to the proxy server 5, which the remote data device 3 has previously been registered. The proxy server 5 retains the previous registration information for the remote data device 3 until the new registration/authentication process has been completed. This prevents a nefarious registration request from making the remote data device 3 inaccessible. It should be noted that, when the remote data device 3 has completed a re-registration/authentication, the proxy server 5 closes any TCP/IP ports associated with the remote data device 3 (central data acquisition system 7 and remote data device 3 connections) and indicates the remote data device 3 as being idle.

The registration request message comprises the header 80 shown in FIG. 8, followed by a phone number code 93 and a cellular component code 95. The phone number code 93 includes a mobile ID number (MIN) or phone number of the cellular module contained in the remote data device 3. The phone number code 93 is used to identify the remote data device 3 to the proxy server 5. The proxy server 5 stores the phone number code 93 and associates the phone number code 93 with the remote data device 3. The cellular component code 95 has data that can identify the remote data device 3 board.

FIG. 10 illustrates an example of an embodiment of an authentication challenge message using the UDP message format 79 shown in FIG. 8. The authentication challenge message 97 is sent by the proxy server 5 to request that the remote data device 3 authenticate itself. The authentication challenge message 97 comprises the header 80 shown in FIG. 8, followed by a registration ID code 98, a challenge tracking code 99, and an authentication challenge code 101. The registration ID code 98 is a unique identifier from the registration request message. The challenge tracking code 99 is incremented for each authentication challenge message that is sent by the proxy server 5 and is used to match up an authentication response message, which is described in FIG. 11. Referring to FIG. 10, the authentication challenge code 101 is a random data used to generate a MD5 digest.

FIG. 11 illustrated an example of an embodiment of an authentication response message using the UDP message format 79 shown in FIG. 8. The authentication response message is sent by remote data device 3 in response to the authentication challenge message from the proxy server 5 to authenticate the remote data device 3. The authentication response message 103 comprises the header 80 shown in FIG. 8, followed by the registration ID code 98, the challenge tracking code 99, and an authentication response code 105. The registration ID code 98 is a unique identifier from the registration request message. The challenge tracking code 99 is incremented for each authentication challenge message that is sent by the proxy server 5 and is used to match up the authentication response message. The authentication response code 105 is a MD5 digest which results from performing the MD5 algorithm on the cellular component code 95, the challenge tracking code 99, a password shared by the remote data device 3 and the proxy server 5, and the authentication challenge code 101.

It should be noted that in the event that the proxy server 5 is restarted, the remote data device 3 re-registers with the proxy server 5. If the proxy server 5 receives a heartbeat message from the remote data device 3 that is not known by the proxy server 5 as being registered, the proxy server 5 sends a restart message to the remote data device 3. The remote data device 3 then reinitiates the registration/authentication process with the proxy server 5.

It should also be noted that during the registration process, the remote data device 3 is responsible for retransmission of UDP packets. The remote data device 3 retransmits the registration request until the remote data device 3 receives an authentication challenge message, and retransmits an authentication response message until the remote data device 3 receives a confirmation message. Once the registration/authentication process is complete, the proxy server 5 is responsible for retransmission of a connection request message until a connection acknowledge message is received or a TCP connection is received from the remote data device 3.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for establishing a secured communication between a remote data device and a host, comprising:
a remote data device that establishes a packet data connection (1XRTT or GPRS) with a cellular carrier; the remote data device be capable of obtaining an IP address from the cellular carrier; the remote data device being capable of transmitting a registration request message that contains an identification code of the remote data device and the IP address, wherein the registration request message identifies the remote data device to the proxy server; and
a proxy server receiving the registration request message to identify the remote data device, the proxy server being capable of transmitting an authentication challenge message based on the registration request message so as to request the remote data device to authenticate itself,
wherein the remote data device generates an authentication response message based on the authentication challenge message and sends the authentication response message to the proxy server,
wherein the proxy server receives the authentication response message and generates a confirmation message to the remote data device whether a communication can be established between the remote data device and the proxy server based on the authentication response message.

2. The system of claim 1, wherein the registration request message further comprises a cellular component code that identifies a cellular component of the remote data device.

3. The system of claim 2, wherein the identity code of the registration request message comprises one of a mobile ID number or phone number of a cellular component of the remote data device, wherein the identity code identifies the remote data device to the proxy server.

4. The system of claim 2, wherein the authentication challenge message comprises the cellular component code of the registration request message and an authentication challenge code, wherein the authentication challenge code is data generated for the remote data device to process so as to generate the authentication response message.

5. The system of claim 4, wherein the authentication response message comprises the identifier code of the registration request message and an authentication response code, wherein the authentication response code comprises an MD5 hash generated from using MD5 algorithm on the cellular component code, the authentication challenge code, and a password code that is shared by the remote data device and the proxy server.

6. The system of claim 5, wherein the authentication challenge message comprises a challenge tracking code that tracks the number of times the authentication challenge message is sent to the remote data device, wherein the authentication response code further comprises the challenge tracking code.

7. The system of claim 6, wherein the confirmation message comprises an authentication ACK message or an authentication NAK message, the proxy server being capable of receiving the authentication response message and determining whether the remote data device can communicate with the proxy server based on the authentication response message.

8. The system of claim 7, wherein determining whether the remote data device can communicate with proxy server comprises matching the MD5 hash with a verification code calculated by the proxy server.

9. The system of claim 1, wherein the remote data device further comprises being capable of transmitting a heartbeat message that is sent periodically to the proxy server to maintain the active status of the remote data device, and to keep the NAT/firewall translation for UDP messages open to the remote data device, the proxy server being capable of sending a server heartbeat message to the remote data device.

10. The system of claim 9, wherein the remote data device further comprises being capable of receiving a restart message from the proxy server when the heartbeat message is not recognized by the proxy server as being registered and responsive to receiving the restart message, the remote data device initiates a registration process with the proxy server.

11. The system of claim 1, wherein the proxy server further comprises being capable of transmitting a connection request message to the remote data device when a host request to communicate with the remote data device and responsive to receiving the connection request message, the remote data device transmits a connection acknowledgement message to the proxy server and establishes a TCP/IP connection to the proxy server for data communication with the host.

12. A method that facilitates registering a remote data device with a proxy server, the method comprising the steps of:
establishing a packet data connection (1XRTT or GPRS) with a cellular carrier;
obtaining an IP address from the cellular carrier;
transmitting to a proxy server a registration request message that contains an identity code of the remote data device and the IP address, wherein the registration request message identifies the remote data device to a proxy server, wherein the registration request message is used to register with the proxy server;
receiving an authentication challenge message from the proxy server to request the remote data device to authenticate itself;
generating an authentication response message based on the authentication challenge message;
transmitting the authentication response message to the proxy server; and
receiving a confirmation message from proxy server whether a registration was achieved between the remote data device and the proxy server based on the authentication response message.

13. The method of claim 12, wherein the registration request message further comprises a cellular component code that identifies a cellular component of the remote data device.

14. The method of claim 13, wherein the identity code of the registration request message comprises one of a mobile ID number or phone number of a cellular component of the remote data device, wherein the identity code identifies the remote data device to the proxy server.

15. The method of claim 14, wherein the authentication challenge message comprises the cellular component code of the registration request message and an authentication challenge code, wherein the authentication challenge code is data generated for the remote data device to process so as to generate the authentication response message.

16. The method of claim 15, wherein the authentication response message comprises the identifier code of the registration request message and an authentication response code, wherein the authentication response code comprises an MD5 hash generated from using MD5 algorithm on the cellular component code, the authentication challenge code, and a password code that is shared by the remote data device and the proxy server.

17. The method of claim 16, wherein the authentication challenge message comprises a challenge tracking code that tracks the number of times the authentication challenge message is sent to the remote data device, wherein the authentication response code further comprises the challenge tracking code.

18. The method of claim 17, wherein the confirmation message comprises an authentication ACK message or an authentication NAK message, which indicates whether the remote data device can communicate with the proxy server based on the authentication response message.

19. The method of claim 18, wherein the proxy server matches the MD5 hash with a verification code calculated by the proxy server to determine whether the remote data device can communicate with proxy server comprises.

20. The method of claim 12, further comprises transmitting a heartbeat message that is sent periodically to the proxy server to maintain the active status of the remote data device and to keep the NAT/firewall translation for UDP messages open to the remote data device, and receiving a server heartbeat message from the proxy server.

21. The method of claim 20, further comprising receiving a restart message from the proxy server when the heartbeat message is not recognized by the proxy server as being registered, and responsive to receiving the restart message, initiating a registration process with the proxy server.

22. The method of claim 12, further comprising receiving a connection request message when a host requests to communicate with the remote data device and responsive to receiving the connection request message, the remote data device transmits a connection acknowledgement message to the proxy server and establishes a TCP/IP connection to the proxy server for data communication with the host.

23. A method that facilitates registering a remote data device with a proxy server, the method comprising the steps of: receiving a registration request message that contains an identity code of the remote data device and the IP address, wherein the registration request message identifies the remote data device;
transmitting an authentication challenge message to the remote data device to request the remote data device to authenticate itself;
receiving an authentication response message based on the authentication challenge message from the remote data device;
generating a confirmation message based on the authentication response message; and
transmitting a confirmation message to the remote data device whether a communication was established between the remote data device and the proxy server.

24. The method of claim 23, wherein the registration request message further comprises a cellular component code that identifies a cellular component of the remote data device.

25. The method of claim 24, wherein the identity code of the registration request message comprises one of a mobile ID number or phone number of a cellular component of the remote data device, wherein the identity code identifies the remote data device to the proxy server.

26. The method of claim 25, wherein the authentication challenge message comprises the cellular component code of the registration request message and an authentication challenge code, wherein the authentication challenge code is data generated for the remote data device to process so as to generate the authentication response message.

27. The method of claim 26, wherein the authentication response message comprises the identifier code of the registration request message and an authentication response code, wherein the authentication response code comprises an MD5 hash generated from using MD5 algorithm on the cellular component code, the authentication challenge code, and a password code that is shared by the remote data device and the proxy server.

28. The method of claim 27, wherein the authentication challenge message comprises a challenge tracking code that tracks the number of times the authentication challenge message is sent to the remote data device, wherein the authentication response code further comprises the challenge tracking code.

29. The method of claim 27, wherein the confirmation message comprises an authentication ACK message or an authentication NAK message, which indicates to the remote data device whether the remote data device can communicate with the proxy server based on the authentication response message.

30. The method of claim 27, further comprising determining whether the remote data device can communicate with proxy server by matching the MD5 hash with a verification code calculated by the proxy server.

31. The method of claim 23, further comprises receiving a heartbeat message that is sent periodically by the remote data device to maintain the active status of the remote data device, and to keep the NAT/firewall translation for UDP messages open to the remote data device; and sending a server heartbeat message to the remote data device.

32. The method of claim 31, further comprising transmitting a restart message to the remote data device when the heartbeat message is not recognized by the proxy server as being registered, responsive to receiving the restart message, the remote data device initiates a registration process with the proxy server.

33. The method of claim 23, further comprising transmitting a connection request message when a host requests to communicate with the remote data device and responsive to receiving the connection request message, the remote data device transmits a connection acknowledgement message to the proxy server and establishes a TCP/IP connection to the proxy server for data communication with the host.

34. A computer readable medium having a proxy manager that facilitates registering a remote data device with a proxy server, the manager for performing the steps of:
receiving a registration request message that contains an identity code of the remote data device and the IP address, wherein the registration request message identifies the remote data device;
transmitting an authentication challenge message to the remote data device to request the remote data device to authenticate itself;
receiving an authentication response message based on the authentication challenge message from the remote data device;
generating a confirmation message based on the authentication response message; and
transmitting a confirmation message to the remote data device whether a communication was established between the remote data device and the proxy server.

35. A computer readable medium having a remote manager that facilitates registering a remote data device with a proxy server, the manager for performing the steps of:
establishing a packet data connection (1XRTT or GPRS) with a cellular carrier;
obtaining an IP address from the cellular carrier;
transmitting to a proxy server a registration request message that contains an identity code of the remote data device and the IP address, wherein the registration request message identifies the remote data device to a proxy server, wherein the registration request message is used to register with the proxy server;
receiving an authentication challenge message from the proxy server to request the remote data device to authenticate itself;
generating an authentication response message based on the authentication challenge message;
transmitting the authentication response message to the proxy server; and
receiving a confirmation message from proxy server whether a registration was achieved between the remote data device and the proxy server based on the authentication response message.
